(19) United States
(12) Patent Application Publication
(10) Pub. No.: US 2025/0307495 A1
(43) Pub. Date: Oct. 2, 2025

(54) Utilization Of Triply Periodic Minimal Surface Structures and Additive Manufacturing for Thermal Management Systems With Enhanced Thermal Properties, Mechanical Properties, and Shape Conformity

(71) Applicants: Jian Liu, Chapel Hill, NC (US); David Cheng, Chapel Hill, NC (US); Shuang Bai, Chapel Hill, NC (US)

(72) Inventors: Jian Liu, Chapel Hill, NC (US); David Cheng, Chapel Hill, NC (US); Shuang Bai, Chapel Hill, NC (US)

(73) Assignee: PolarOnyx, Inc., Chapel Hill, NC (US)

(21) Appl. No.: 19/036,811

(22) Filed: Jan. 24, 2025

Related U.S. Application Data
(60) Provisional application No. 63/731,082, filed on Apr. 1, 2024.
(60) Provisional application No. 63/731,422, filed on May 1, 2024.

(51) Int. Cl. G06F 30/23; B33Y 50/00; B33Y 80/00; F28F 21/00; G06F 30/28; G06F 113/08; G06F 119/08

(52) U.S. Cl. CPC G06F 30/23; F28F 21/00; G06F 30/28; B33Y 50/00; B33Y 80/00; F28F 2255/00; G06F 2113/08; G06F 2119/08

(57) ABSTRACT

Methods and apparatuses for utilizing triply periodic minimal surface structures for additive manufacturing of a thermal management system are disclosed, wherein the thermal management system comprises: a solid structure; a triply periodic minimal surface structure within the solid structure, wherein the triply periodic minimal surface structure comprises a first fluid channel and a second fluid channel; a first inlet coupled to the solid structure and configured to pass a first fluid into the first fluid channel; a second inlet coupled to the solid structure and configured to pass a second fluid into the second fluid channel; a first outlet coupled to the solid structure and configured to pass the first fluid out of the first fluid channel; and a second outlet coupled to the solid structure and configured to pass the second fluid out of the second fluid channel. Other embodiments are described and claimed.

### Cross Reference to Related Applications

This application claims the benefit of the filing date of U.S. Provisional Patent Application Ser. No. 63/731,082, filed on Apr. 1, 2024, entitled “Utilization of TPMS Structures and Additive Manufacturing to Enhance Thermal and Mechanical Properties, and Shape Conformity” and U.S. Provisional Patent Application Ser. No. 63/731,422, filed on May 1, 2024, entitled “Hollow Wall/Core TPMS Structures and Additive Manufacturing.” All of the foregoing applications are hereby incorporated by reference herein in their entirety.

### Statement Regarding Federally Sponsored Research

The U.S. Government has a paid-up license in this invention and the right in limited circumstances to require the patent owner to license others on reasonable terms as provided for by the terms of the NASA SBIR contract 80NSSC22CA197, NASA SBIR contract 80NSSC24PB411, and DOE SBIR contract DE-SC0025372.

### III. BACKGROUND

The invention relates generally to the field of additively manufactured shape conformable thermal and mechanical components. More particularly, the invention relates to the utilization of triply periodic minimal surface (TPMS) structures and additive manufacturing (AM) to increase surface to volume ratio and mechanical strength to mass ratio to improve heat transfer and mechanical strength properties for a variety of thermal management systems such as regenerators, recuperators, heat exchangers (HX), and radiators in any arbitrary shape to match the available geometry.

### IV. SUMMARY

In one respect, disclosed is a method for utilizing triply periodic minimal surface structures for additive manufacturing of a thermal management system, the method comprising: (a) determining a required heat transfer power; a required pressure drop, a required dimension restriction, a required material, and a required connector type for the thermal management system; (b) modeling an initial volume, an initial dimension, a layout of inlet and outlet channels and connectors, a type of lattice, a unit length of the type of lattice, and a wall thickness of the type of lattice for the thermal management system; (c) generating mesh files from the modeling of the thermal management system; (d) using fluid simulation software to calculate the mesh and boundary conditions and to generate a simulated heat transfer power, a simulated pressure drop, and a simulated flow rate; (e) determining if the simulated heat transfer power meets the required heat transfer power; (f) if the determination made in step (e), above, is that the simulated heat transfer power does not meet the required heat transfer power then: increase the initial volume, reduce the unit length of the type of lattice, and repeat steps (b) through (e) using the increased initial volume and reduced unit length of the type of lattice; (g) if the determination made in step (e), above, is that the simulated heat transfer power does meet the required heat transfer power then determining if the simulated pressure drop meets the required pressure drop; (h) if the determination made in step (g), above, is that the simulated pressure drop does not meet the required pressure drop then: optimize the layout of inlet and outlet channels, change the unit length of the type of lattice, change the initial dimension for the thermal management system, and repeat steps (b) through (g) using the optimized layout of inlet and outlet channels, the changed unit length of the type of lattice, and the changed initial dimension for the thermal management system; and (i) if the determination made in step (g), above, is that the simulated pressure drop does meet the required pressure drop then exporting an additive manufacturing file format file for additive manufacturing of the thermal management system.

In another respect, disclosed is a thermal management system comprising: a solid structure; a triply periodic minimal surface structure within the solid structure, wherein the triply periodic minimal surface structure comprises a first fluid channel and a second fluid channel; a first inlet coupled to the solid structure and configured to pass a first fluid into the first fluid channel; a second inlet coupled to the solid structure and configured to pass a second fluid into the second fluid channel; a first outlet coupled to the solid structure and configured to pass the first fluid out of the first fluid channel; and a second outlet coupled to the solid structure and configured to pass the second fluid out of the second fluid channel.

Numerous additional embodiments are also possible.

### V. BRIEF DESCRIPTION OF THE DRAWINGS

Other objects and advantages of the invention may become apparent upon reading the detailed description and upon reference to the accompanying drawings.

FIGS. 1A and 1B show schematic illustrations of four examples of triply periodic minimal surface lattices and the fluid and walled components of TMPS unit cell structures for heat exchangers (HX), respectively.

FIG. 2 shows the definition of unit lengths in three directions, the wall thickness parameters, and a graph of the surface area to volume ratio versus unit length for a gyroid.

FIG. 3 is a block diagram illustrating a method for modeling and designing of a triply periodic minimal surface heat exchanger.

FIG. 4 is a schematic illustration of a heat exchanger, in accordance with some embodiments.

FIG. 5 is a table showing the parameters of the two types of heat exchangers illustrated in FIG. 4, in accordance with some embodiments.

FIG. 6 is a schematic illustration of the heat exchanger with a gyroid unit length of 5 mm, in accordance with some embodiments.

FIG. 7 is a schematic illustration of the heat exchanger with a gyroid unit length of 10 mm, in accordance with some embodiments.

FIG. 8 is a table showing the simulation results assuming a gyroid wall thickness of 0.4 mm and a flow rate of 0.48 kg/s, in accordance with some embodiments.

FIG. 9 is a table showing the two work conditions of the BT3x8-20 HX.

FIG. 10 is a table showing the parameters of an HX-70 as described herein compared to the BT3x8-20 HX.

FIGS. 11A and 11B are graphs showing the normalized heat transfer coefficient and normalized thermal capacity, respectively, as a function of thermal conductivity for three different gyroid wall thicknesses.

FIGS. 12A and 12B are graphs showing the performances of the HX-70 compared to the BT3x8-20 HX.

FIG. 13 is a simulated thermal field of the HX-70 by conjugated models, in accordance with some embodiments.

FIG. 14 is a thermal stress diagram of the HX-70, in accordance with some embodiments.

FIG. 15 is a stress diagram of the HX-70 under thermal load and fluid pressure, in accordance with some embodiments.

FIG. 16 shows cross section schematic illustrations of the inner structure of the cubic HX70-10*10*10 and HX-70-5*5*5 along with the inlet and outlet channels, in accordance with some embodiments.

FIG. 17 is a table showing the optimized additive manufacturing parameters for fabrication of an HX, in accordance with some embodiments.

FIG. 18 shows cross section schematic illustrations of an optimized HX, in accordance with some embodiments.

FIG. 19 are schematic illustrations of the lattice structure at different flow angles.

FIG. 20 is a graph showing the pressure drop at different angles.

FIGS. 21A and 21B are photographs of a partial additively manufactured gyroid HX and a complete additively manufactured gyroid HX, respectively, undergoing a water leakage test, in accordance with some embodiments.

FIGS. 22A and 22B are schematic illustrations of the layer distribution under different layer heights, in accordance with some embodiments.

FIG. 23 is a schematic illustration of a graded lattice structure for transition from lattice to solid portions, in accordance with some embodiments.

FIG. 24 is a graph showing the experimental results of topology optimized gyroid heat exchangers, with 5 mm lattice and 10 mm lattice, compared to the BT3x8-20 heat exchanger, in accordance with some embodiments.

FIG. 25 shows schematic illustrations of different shaped thermal management devices and mechanical components, in accordance with some embodiments.

FIG. 26 is a schematic illustration of a cross section of a multi-layer beam structure, in accordance with some embodiments.

FIG. 27 is a table showing the ratio of area moment of inertia and equivalent mass of the beam with different elastic modulus, in accordance with some embodiments.

FIG. 28 is a graph showing the ratio of area moment of inertia and equivalent mass of the beam as a function of effective modulus, in accordance with some embodiments.

FIG. 29 is a table showing the modeling results of the beam with different heights.

FIGS. 30A and 30B are graphs showing the simulated ratio of the beam inertia and mass versus ratio of volume of the lattice infilled structure and the equivalent bending stiffness versus ratio of volume of the lattice infilled structure, respectively, in accordance with some embodiments.

FIGS. 31A, 31B, and 31C are schematic illustrations of a gyroid mirror structure with a 40 mm lattice length, a gyroid mirror structure with a 30 mm lattice length, and a gyroid core structure, respectively, in accordance with some embodiments.

FIG. 32 shows the modeling of the gravity deformation for two Super Invar gyroid structures, one with a 40 mm lattice length and the other with a 30 mm lattice length, in accordance with some embodiments.

FIG. 33 is a table showing the performance comparisons between beryllium and Super Invar for a 10-inch gyroid mirror structure, in accordance with some embodiments.

FIG. 34 is a table showing the thermal deformations of 10-inch plates of gyroid Super Invar, gyroid beryllium, and solid beryllium, at various temperature differences, in accordance with some embodiments.

FIG. 35 is a schematic illustration of the generation of a hollow walled gyroid structure, in accordance with some embodiments.

FIG. 36 is a schematic illustration of the composition of Fluid A, in accordance with some embodiments.

FIG. 37 is a schematic illustration of the thin walled gyroid structure of Fluid B, in accordance with some embodiments.

FIG. 38 is a schematic illustration of the components of an HX-40 hollow walled gyroid structure as well as a complete HX-40 hollow walled gyroid structure, in accordance with some embodiments.

FIG. 39 is a table showing the parameters of a gyroid structure (based on the HX-40 core) with different wall thickness, in accordance with some embodiments.

FIG. 40 is a graph of the surface area (with lattice unit lengths of 10 mm*10 mm*10 mm and 7 mm*7 mm*7 mm) as a function of input wall thickness, in accordance with some embodiments.

FIG. 41 is a graph of the Fluid A volume (with a lattice unit length of 10 mm*10 mm*10 mm) and the solid volume as a function of input wall thickness, in accordance with some embodiments.

FIG. 42 is a table showing the surface areas for heat transfer and fluid volumes for an HX-40 with hollow gyroid structure and an HX-40 with gyroid lattice of 5 mm*5 mm*5 mm, in accordance with some embodiments.

FIG. 43 is a graph of the heat transfer coefficient versus flow rate for an HX-40 with hollow gyroid structure and an HX-40 with gyroid lattice of 5 mm*5 mm*5 mm, in accordance with some embodiments.

FIG. 44 is a graph of the pressure drop versus flow rate for an HX-40 with hollow gyroid structure and an HX-40 with gyroid lattice of 5 mm*5 mm*5 mm, in accordance with some embodiments.

FIG. 45 is a graph of the ratio of the heat transfer coefficient times the area to pressure drop versus flow rate, in accordance with some embodiments.

FIG. 46 is a photograph of a gyroid regenerator heat exchanger with 2 mm×4 mm×80 cells per circle layer, in accordance with some embodiments.

FIG. 47 is a photograph of the cross section of the post polished gyroid regenerator of FIG. 46, in accordance with some embodiments.

FIG. 48 are 5× microscope photographs of the post polished gyroid regenerator of FIG. 46 at points A, B, C, and D as indicated in FIG. 47, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### VI. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Heat exchangers are present in all major industrial fields, being an essential component of most engineering systems. The design of an HX is a balance between maximizing the surface area in order to transfer heat and minimizing the pressure drop of the HX. In the aviation and automotive industries, compact HXs are widely desired thanks to their relatively small volumes and consequently low weights and high thermal efficiency. It is very important to reduce the weight of HXs, by acting on the size/weight, while simultaneously reaching high performance levels in terms of thermal efficiency. In aeronautical and aerospace applications, the most commonly used HXs are the finned plate type due to their relative compactness, good efficiency, and ease of system integration. Most of the finned plates in compact HXs are parallel to each other because it is difficult to fabricate other fin geometries using conventional manufacturing capabilities. Modern AM techniques provide new ways to manufacture HXs with complex geometries.

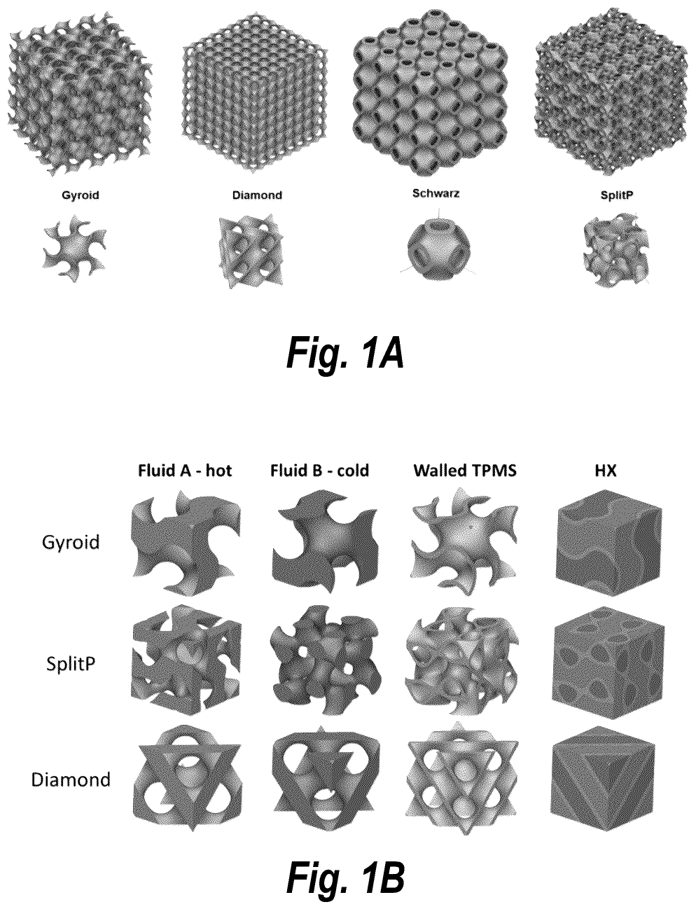

FIGS. 1A and 1B show schematic illustrations of four examples of triply periodic minimal surface lattices and the fluid and walled components of TMPS unit cell structures for heat exchangers (HX), respectively.

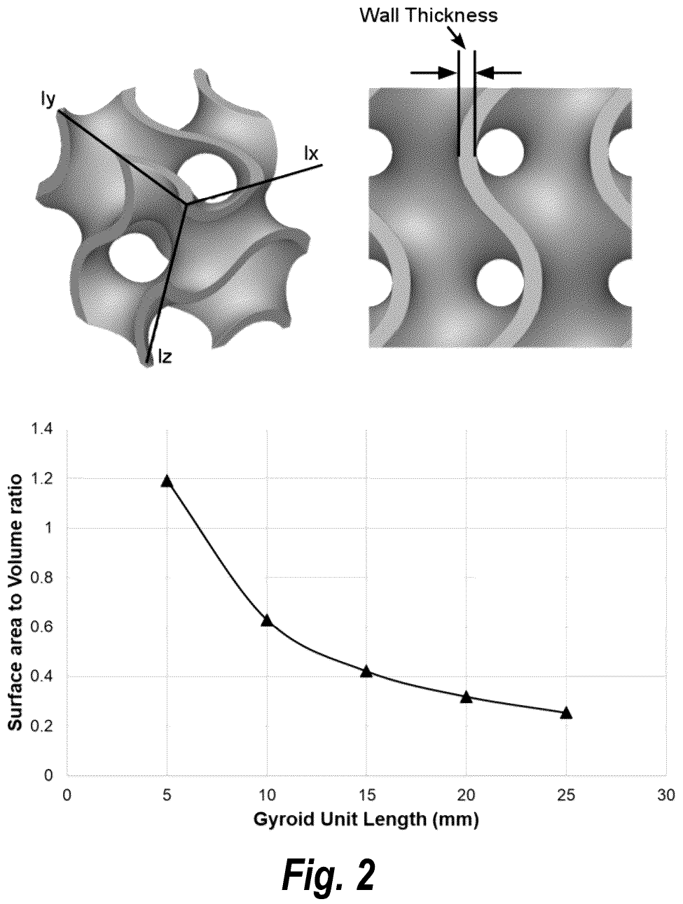

FIG. 2 shows the definition of unit lengths in three directions, the wall thickness parameters, and a graph of the surface area to volume ratio versus unit length for a gyroid.

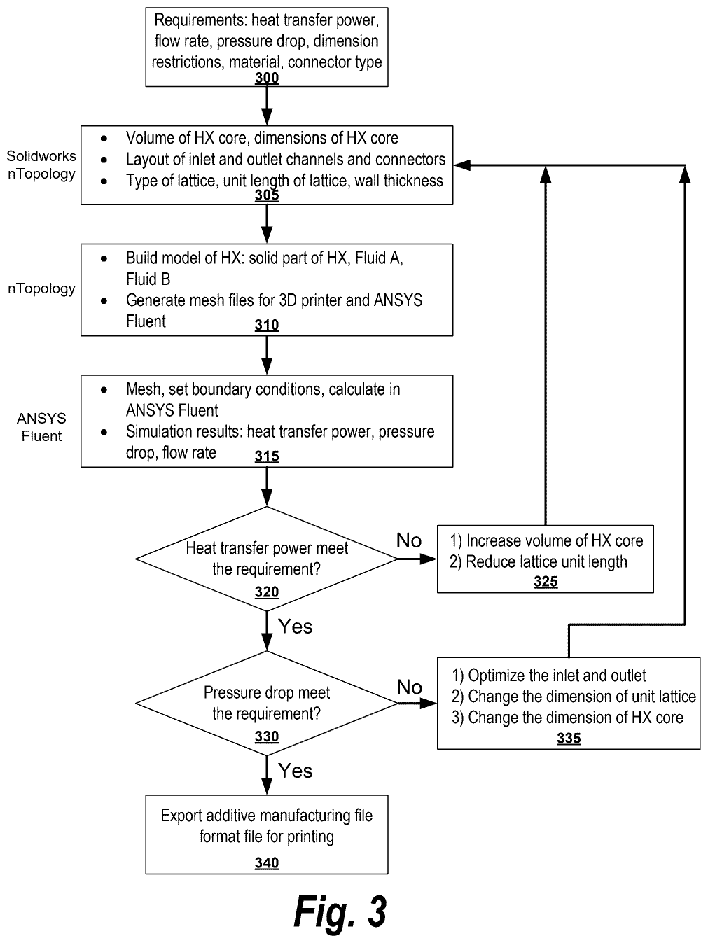

FIG. 3 is a block diagram illustrating a method for modeling and designing of a triply periodic minimal surface heat exchanger.

Some examples of triply periodic minimal surface structures include but are not limited to gyroid, diamond, Schwarz, SplitP, IWP, Primitive, and Fischer-Koch-S, etc. FIGS. 1A and 1B show schematic illustrations of four types of triply periodic minimal surface lattices and the fluid and walled components of TMPS unit cell structures for heat exchangers. Due to TPMS's unique capability in providing large surface area to volume ratios and operating at high turbulent modes, these structures have recently being explored in heat exchangers and achieved unprecedented performance, by taking advantages of additive manufacturing technology. The gyroid structure is used as the example to illustrate the design and modeling method. The equation for a gyroid is:

$$sin \frac{2 π x}{a} cos \frac{2 π y}{a} + sin \frac{2 π y}{a} cos \frac{2 π z}{a} + sin \frac{2 π z}{a} cos \frac{2 π x}{a}$$

where a is the gyroid unit length. FIG. 2 shows a single gyroid cell unit with definitions for modeling: the gyroid unit length in three directions (lx, ly, and lz), the lattice wall thickness, and the surface area to volume ratio with different unit lengths. A large gyroid structure, as shown in FIGS. 1A, is assembled with copies of itself by using commercial software such as Solidworks® and nTopology®. FIG. 3 shows the flow chart to design and model the HX. Processing starts at step 300 where the requirements for the heat transfer power, pressure drop, dimension restrictions, material, and connector type for the HX are determined. Next, at step 305, Solidworks® or nTopology® are used to model an initial volume and dimensions of HX core, layout of inlet and outlet channels and connectors, type of lattice, unit length of lattice, and wall thickness. At step 310, nTopology® is used to build the HX model with the solid part of the HX, Fluid A, and Fluid B and to generate mesh files for 3D printers and fluid simulation software such as ANSYS Fluent. At step 315, with ANSYS Fluent, the mesh and boundary conditions are calculated and simulation results for heat transfer power, pressure drop, and flow rate are generated. At decision step 320, a determination is made whether or not the heat transfer power requirements are met. If the requirements are not met, processing continues to step 325 where the volume of the HX core is increased and the lattice unit length are reduced. Modeling and simulation is then repeated again from steps 305 to 320. If the heat transfer power requirements are met at decision step 320, processing continues to step 330 where a determination is made whether or not the pressure drop requirements are met. If the requirements are not met, processing continues to step 335 where the inlet and outlet are optimized, the unit lattice dimension is changed, and the HX core dimension is changed. Modeling and simulation is then repeated again from steps 305 to 330. Several iterations of steps 305 to 330 may be needed to optimize the HX performance. If the power drop requirements are met at decision step 330, processing continues to step 340 where an additive manufacturing file format file, such as an STL file, is exported for 3D printing of the HX.

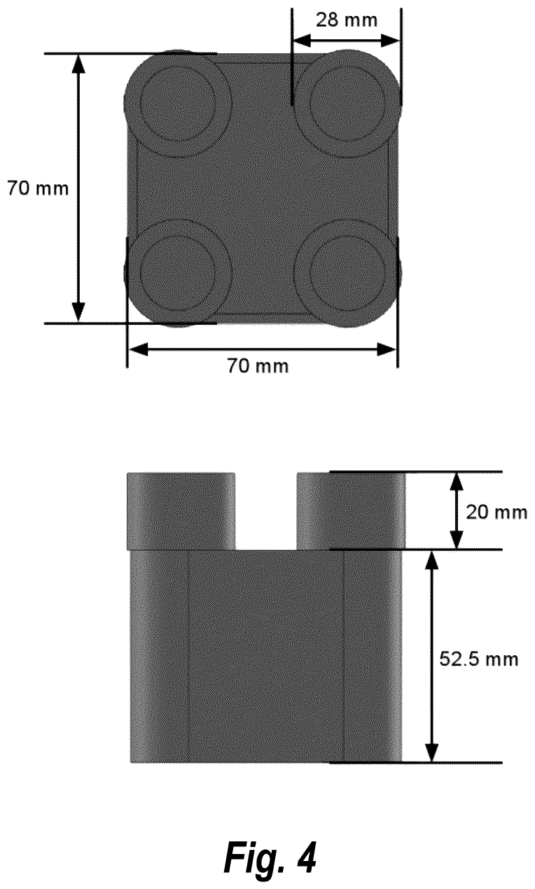

FIG. 4 is a schematic illustration of a heat exchanger, in accordance with some embodiments.

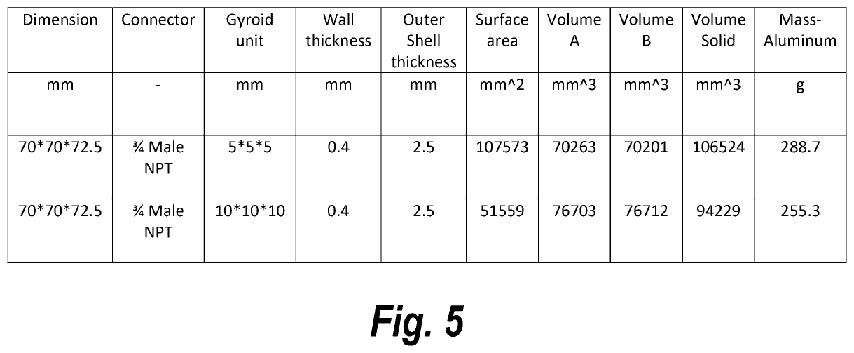

FIG. 5 is a table showing the parameters of the two types of heat exchangers illustrated in FIG. 4, in accordance with some embodiments.

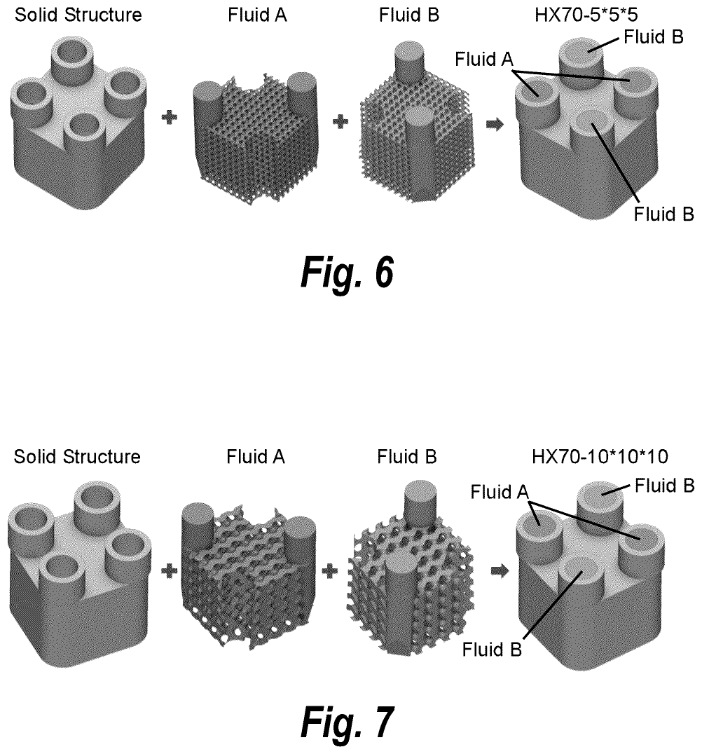

FIG. 6 is a schematic illustration of the heat exchanger with a gyroid unit length of 5 mm, in accordance with some embodiments.

FIG. 7 is a schematic illustration of the heat exchanger with a gyroid unit length of 10 mm, in accordance with some embodiments.

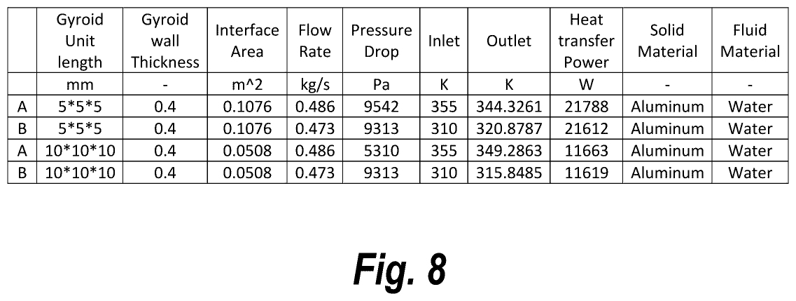

FIG. 8 is a table showing the simulation results assuming a gyroid wall thickness of 0.4 mm and a flow rate of 0.48 kg/s, in accordance with some embodiments.

From the modeling and design flowchart of FIG. 3, two high-efficient cubic HXs (named as HX-70-5*5*5 and HX70-10*10*10) were designed for laser AM. The dimensions of HX-70-5*5*5 and HX70-10*10*10 are shown in FIG. 4. The parameters of these two types of cubic HX-70 are shown in the table of FIG. 5. The material of the HX-70 is aluminum. Heat exchanger HX70-5*5*5 has a gyroid unit with length 5*5*5 mm, as illustrated in FIG. 6. Heat exchanger HX70-10*10*10 has a gyroid unit with length 10*10*10 mm, as illustrated in FIG. 7. Fluid A and fluid B indicate fluids (such as water, air, and fuel) at different temperatures. The volume of the HX core is mainly used to simulate thermal transfer parameters including surface area, fluid field, heat transfer coefficient (HTC), pressure drop, and heat transfer capacity. The table of FIG. 8 shows the simulation results under assumptions that the wall thickness of the gyroid lattice is 0.4 mm and the flow rate is 0.48 kg/s.

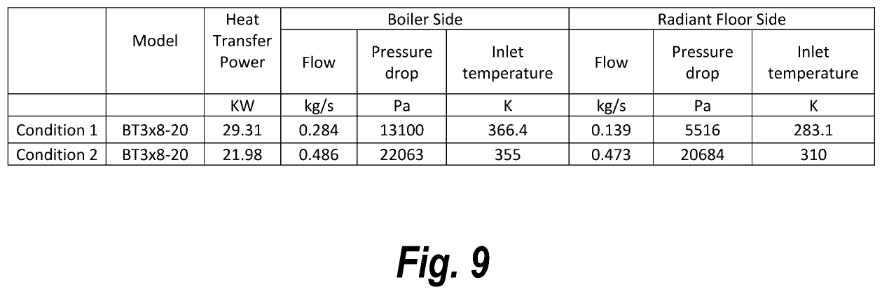

FIG. 9 is a table showing the two work conditions of the BT3x8-20 HX.

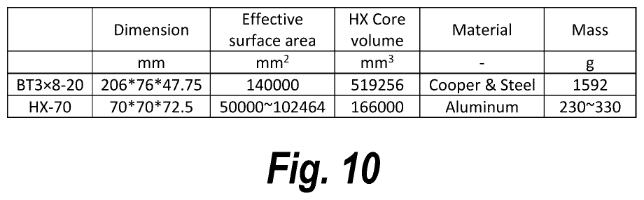

FIG. 10 is a table showing the parameters of an HX-70 as described herein compared to the BT3x8-20 HX.

The heat transfer coefficient was used to do the comparison of HX with different types of TPMS. The overall heat transfer coefficient in the clean condition, Uc, shall be calculated as:

$$\vert Uc = Q {t}_{avg} / ( LMTD * A )$$

where Qt_{avg} is total average heat transfer rate, calculated as the average of the hot stream heat transfer rate and the cold stream heat transfer rate and t_{avg} is the total average, LMTD is the logarithmic mean temperature difference which is defined as follows:

$$LMTD = \frac{Δ T 1 - Δ T 2}{ln ( Δ T 1 / Δ T 2 )}$$

where ΔT1 is the temperature difference between the inlet and outlet of the hot fluid, ΔT2 is the temperature difference between the inlet and outlet of the cold fluid, and A is the effective surface area of the HX. The HX-70 was compared with the commercial 20 kW HX, BT3x8-20. The two main work conditions of BT3x8-20 are shown in the table of FIG. 9. The HX-70 is three times smaller in volume, and at least 5 times lighter in weight than BT3x8-20, as shown in the table of FIG. 10. Additionally, aluminum alloy is much cheaper than copper alloys or steels.

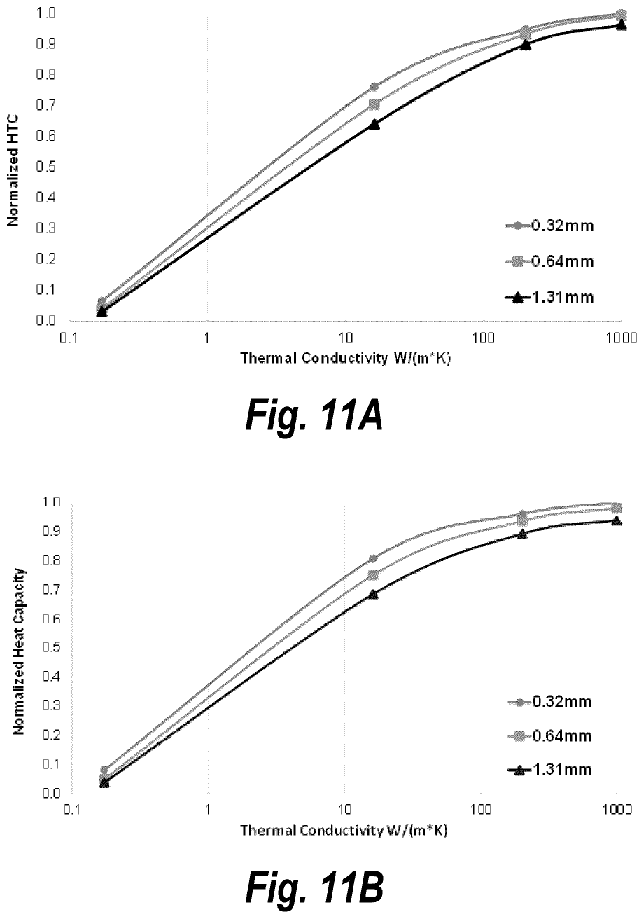

FIGS. 11A and 11B are graphs showing the normalized heat transfer coefficient and normalized thermal capacity, respectively, as a function of thermal conductivity for three different gyroid wall thicknesses.

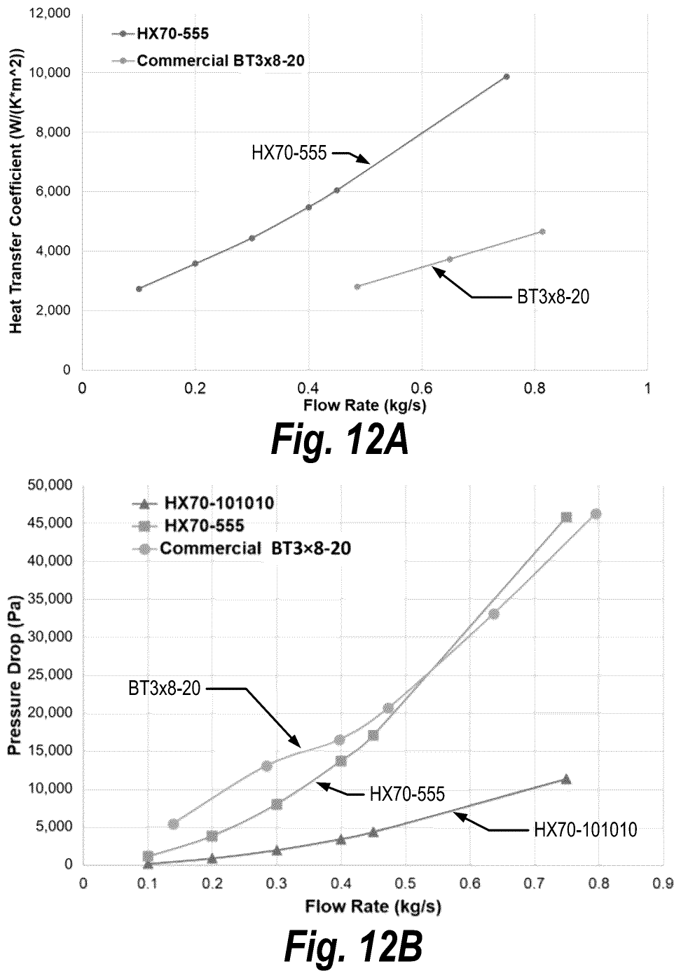

FIGS. 12A and 12B are graphs showing the performances of the HX-70 compared to the BT3x8-20 HX.

The impact of thickness and thermal conductivity on HTC and pressure drop were investigated by using the flow chart of FIG. 3. FIGS. 11A and 11B show the normalized HTC and normalized thermal capacity, respectively, as a function of thermal conductivity for three different gyroid wall thicknesses: 0.32 mm, 0.64 mm, and 1.31 mm. In the simulation, all data at the various wall thickness were normalized to the maximum HTC (W/K·m²) or thermal capacity (Watt) in the simulated range of thermal conductivity from 0.1 to 1000 W/m K. Obviously, highest thermal conductivity and lowest wall thickness gives the maximum HTC or thermal capacity. It shows that the HTC or thermal capacity is less sensitive to the thickness change. Less than 5% change occurs when thickness changes from 0.32 mm to 1.31 mm. More interestingly, when the thermal conductivity is higher than 100 W/m K, less than 10% change of HTC or thermal capacity happens when varying thermal conductivity from 100 to 1000 W/m K. This is very important for cost and weight reduction of HXs, because aluminum alloys can be used to obtain comparable results as with copper alloys.

Using the pressure drop of the HX-70, as shown in FIG. 8, the HX-70 performances were compared with the commercial HX, BT3x8-20 and are shown in FIGS. 12A and 12B. It shows that a 2× reduction in size, a 2-3× reduction in pressure drop, and a 2-3× increase in heat transfer coefficient can be achieved for a 3x3×3 cubic inch gyroid HX (HX-70-555, 0.4 mm wall thickness, 5 mm gyroid unit length) in comparison with a commercial 20 kW plate HX (model BT3x8-20, dimension 3×8×2.2 cubic inch) at the same flow rate.

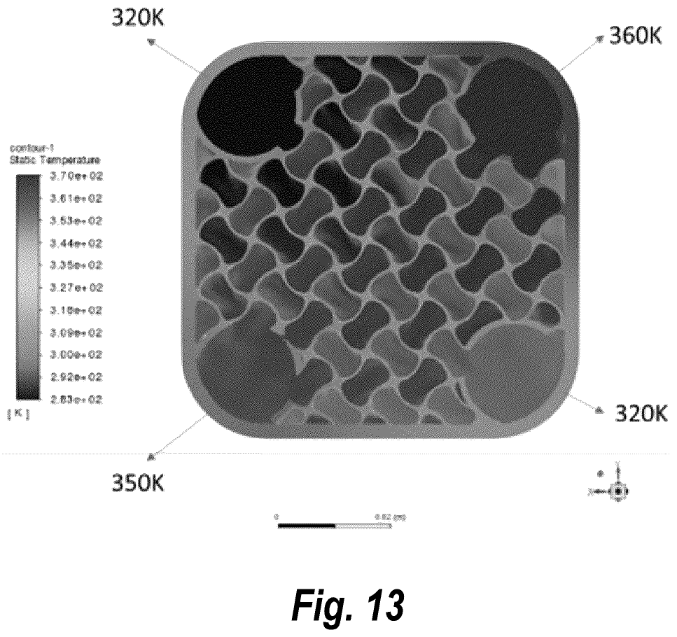

FIG. 13 is a simulated thermal field of the HX-70 by conjugated models, in accordance with some embodiments.

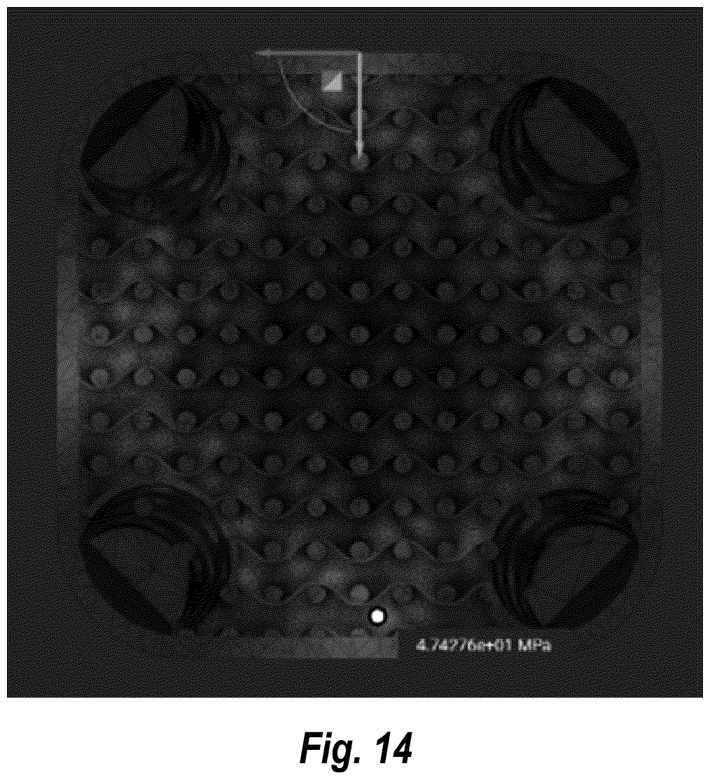

FIG. 14 is a thermal stress diagram of the HX-70, in accordance with some embodiments.

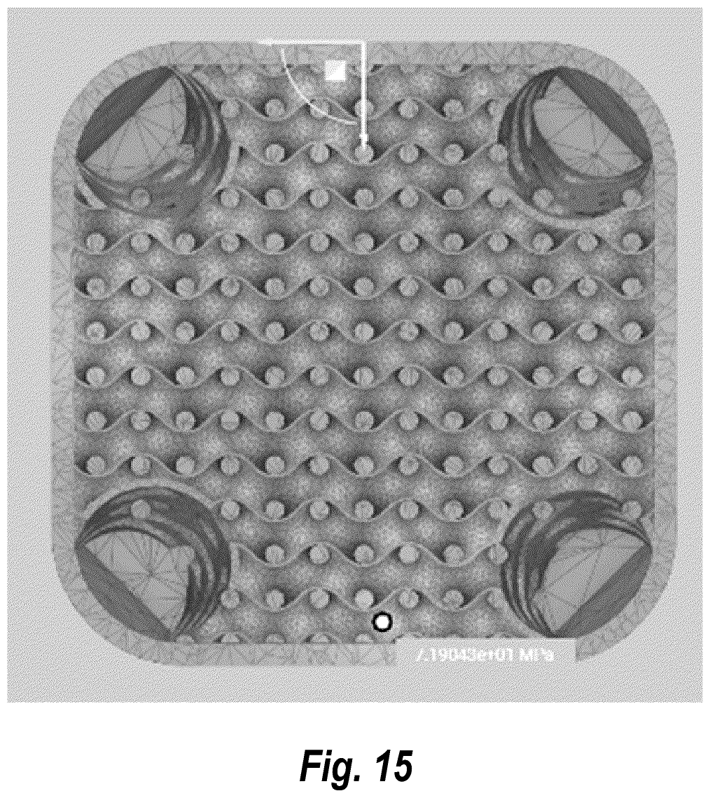

FIG. 15 is a stress diagram of the HX-70 under thermal load and fluid pressure, in accordance with some embodiments.

Using ANSYS Fluent, the temperature field of the HX-70 (with the capability of 20 kW thermal power management) was simulated and is shown in FIG. 13. The mechanical stress of the HX-70-10*10*10-0.4 mm made from aluminum under 2 MPa water pressure in one volume is about 30 MPa. The distribution of the temperature may result in the thermal stress in the HX-70 during operation. The thermal stress of the HX-70 was calculated based on the temperature field. The temperature difference is 40° C. for water fluid. The thermal stress of the HX-70 is shown in FIG. 14. The maximum stress was about 47.5 MPa, much less than aluminum strength (240 MPa). The result under both thermal load and fluid operation pressure is shown in FIG. 15. The water fluid pressure load is set at 2 MPa. The maximum stress of the HX-70 is about 72 MPa, which is still less than aluminum strength (240 MPa), and comparable with the strength of polycarbonate. This indicates that the gyroid structure is not only for thermal transfer enhancement but also for mechanical strength with the TPMS type networking support.

FIG. 16 shows cross section schematic illustrations of the inner structure of the cubic HX70-10*10*10 and HX-70-5*5*5 along with the inlet and outlet channels, in accordance with some embodiments.

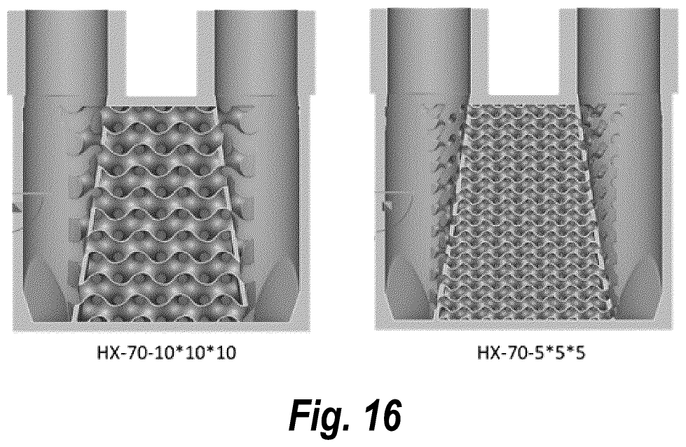

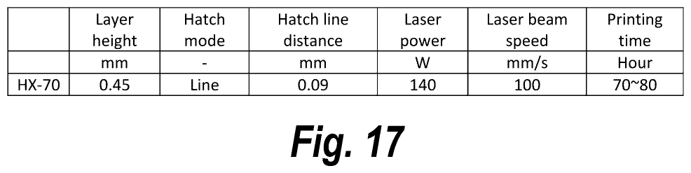

FIG. 17 is a table showing the optimized additive manufacturing parameters for fabrication of an HX, in accordance with some embodiments.

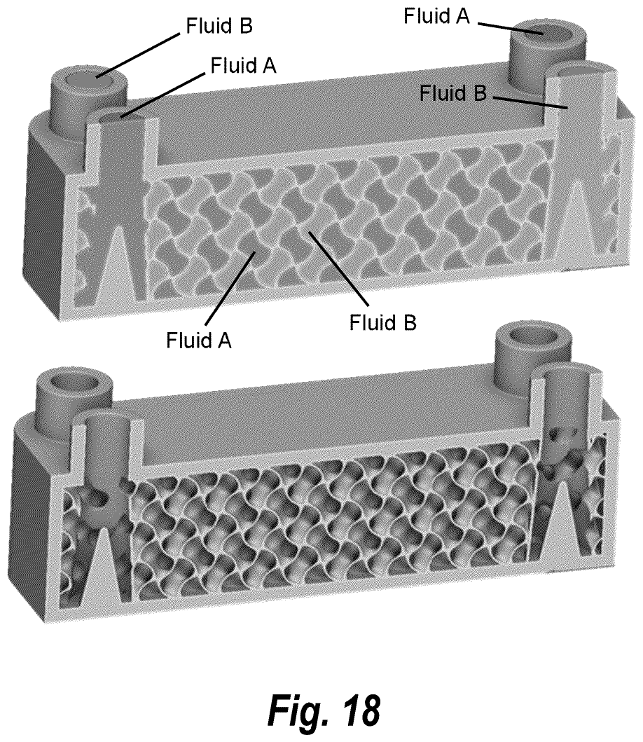

FIG. 18 shows cross section schematic illustrations of an optimized HX, in accordance with some embodiments.

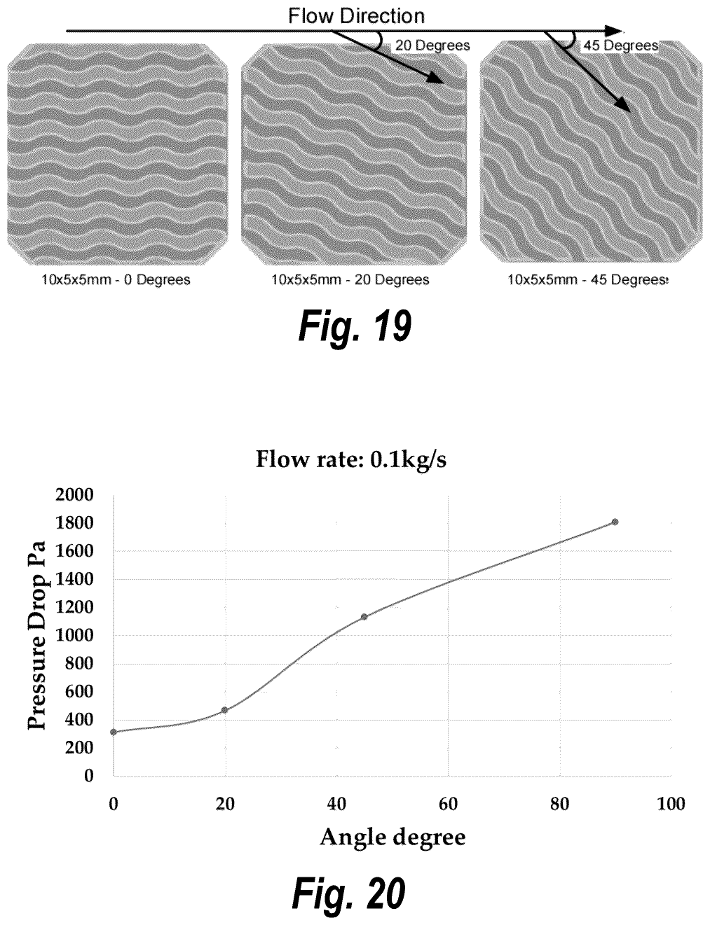

FIG. 19 are schematic illustrations of the lattice structure at different flow angles

FIG. 20 is a graph showing the pressure drop at different angles.

The inlets and outlets of HX-70-5*5*5 and HX70-10*10*10 were designed to make the fluids transfer to the gyroid structure sections. FIG. 16 shows the inner structure of the cubic HX-70-5*5*5 and HX70-10*10*10 along with the inlet and outlet channels. The inner structures shown in FIG. 16 are not optimized to reduce the resistance for flow in order to achieve optimized pressure drop. However, the HTC and thermal transfer capacity should not be impacted and allow further optimization of the TPMS structures. FIG. 17 shows the optimized additive manufacturing parameters for fabrication of an optimized HX. FIG. 18 shows cross section schematic illustrations, with and without Fluids A and B, of an optimized HX, where an open section provides for reduced resistance for fluid flow between the TPMS structure and the inlets and outlets.

The flow angle shown in FIG. 19 is the angle between the flow direction and the lattice's longest edge direction in a 10×5×5 mm gyroid lattice. The pressure drop can be influenced by the flow angle between the fluid at the inlets and the TPMS structure. Larger flow angles increase the pressure drop significantly as shown in the graph of FIG. 20 of pressure drop versus flow angle at a flow rate of 0.1 kg/s.

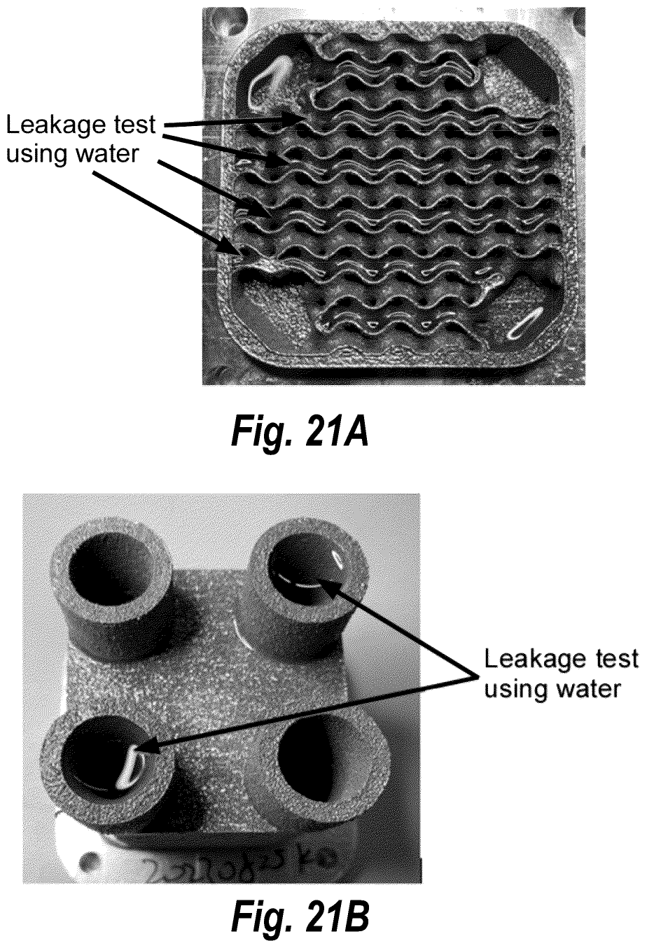

FIGS. 21A and 21B are photographs of a partial additively manufactured gyroid HX and a complete additively manufactured gyroid HX, respectively, undergoing a water leakage test, in accordance with some embodiments.

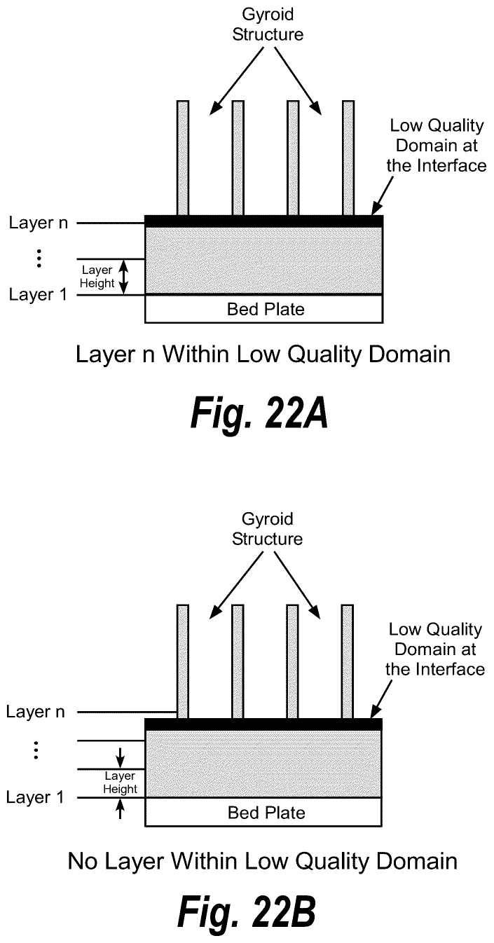

FIGS. 22A and 22B are schematic illustrations of the layer distribution under different layer heights, in accordance with some embodiments.

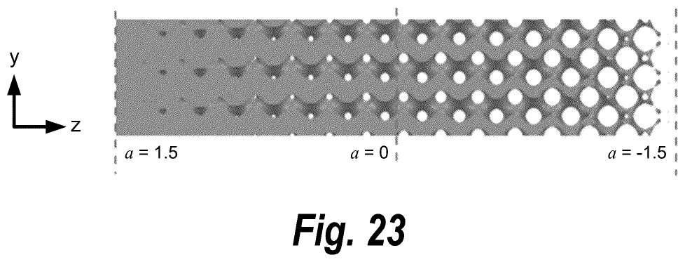

FIG. 23 is a schematic illustration of a graded lattice structure for transition from lattice to solid portions, in accordance with some embodiments.

Leakage between the two fluid channels, Fluid A and Fluid B, in the HX is not allowed. To test for any leakage, water was added to one of the channels. If after several hours the other unfilled channel has any of the water from the filled channel, it indicates the two channels are interconnected with each other somewhere. FIGS. 21A and 21B show an additively manufactured gyroid HX, in a partial and complete state, respectively, holding water in only one of the fluid channels. Thus showing that additively manufactured aluminum HX can be printed with no water leakage between adjacent fluid channels.

From an intensive water leakage test investigation, leakage is mainly located at the interface between the gyroid structure and the bed plate used for additive manufacturing. The main reason is that there is a low-quality domain at the interface. The height of the domain is about 10 μm. If one layer is located within this domain, the layer will have low quality and may result in leakage at this layer. The low-quality domain shown as the black layer in FIGS. 22A and 22B is generated in the mesh procedure and is hard to eliminate. The layer height can be changed to avoid the low-quality domain. If the layer is not within the low-quality domain, the layer may have good quality and can reduce the risk of leakage. Before printing, the layer quality at the interface needs to be carefully checked. The layer with low quality needs to be avoided by choosing the proper layer height. A graded lattice structure, such as the one schematically illustrated in FIG. 23, where a is the gyroid unit length, provides an excellent transition from lattice to solid portions which permits the local tailoring of mechanical strength and coefficient of thermal expansion (CTE) in order to achieve the best strength to weight ratio.

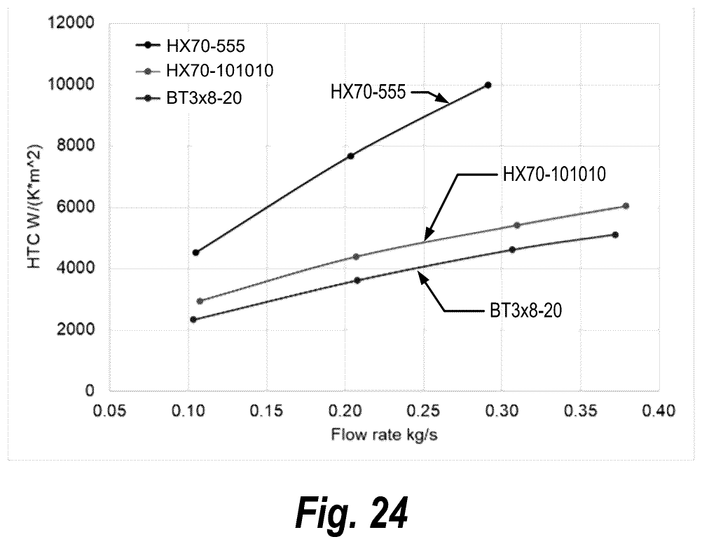

FIG. 24 is a graph showing the experimental results of topology optimized gyroid heat exchangers, with 5 mm lattice and 10 mm lattice, compared to the BT3x8-20 heat exchanger, in accordance with some embodiments.

The heat transfer performance of the additively manufactured TPMS HX was tested and is shown in the heat transfer coefficient (HTC) versus flow rate graph of FIG. 24. It shows that HX70-555 (5 mm lattice length) has significantly high HTC, thanks to its operating at a high turbulent mode. However, due to the inlet and outlet, the HXs were not optimized for reduction of flow resistance and the pressure drop is still high. On-going optimization of entrances to the gyroid HX structures is targeting to reduce the pressure level comparable to the commercial HX.

FIG. 25 shows schematic illustrations of different shaped thermal management devices and mechanical components, in accordance with some embodiments.

TPMS HX will find a variety of applications where size, efficiency, weight, and cost play important roles since TPMS HX may be designed and 3D printed to match any application. These areas include, among others, space aircrafts, defense, high power electronics, nuclear energy, and waste energy recovery. For example, in space aircraft, TPMS will resolve future challenges related to the increase of electrically powered subsystems, ultra-high bypass geared turbofan engines, as well as the possible advent of electrified or nuclear propulsion. In high power electronics, the high-efficient cooling and flexible thermal management solutions meet the critical demands with the continuous miniaturization and rapid increase of heat flux of electronic devices. In waste energy recovery, there is a strong need to develop low-cost advanced heat exchangers that increase heat transfer coefficients and that can withstand corrosive environments in heat recovery systems. FIG. 25 shows a variety of shape conformable thermal management devices and mechanical components where TPMS structures may be utilized. Each of these shapes or combination thereof may be used for thermal management devices.

TPMS HX may be 3D printed using various metal alloys (Al alloys such as A16061, AlSi10Mg, etc., Steel alloys such as 316 and 304, Copper alloys, and Inconel alloys), Super Invar (with its near zero CTE), polymers and polymer composites, polycarbonate (PC) (with a glass transition temperature Tg of 147° C., a melting point of 316° C., a density of 1.2 g cm³, a thermal conductivity of 0.22 W/m·K, a tensile strength of 75 MPa, a compression strength of 80 MPa, and a TEC 70 ppm K), acrylonitrile butadiene styrene (ABS) (with a glass transition temperature Tg 105° C., a melting point of 230° C., a density of 1.53 g cm³, a thermal conductivity of 0.1 W/m·K, a tensile strength of 43 MPa, and a high thermal conductivity of 2000 W/m·K). Polymer composites can be formed by using nano-diamond or nano-graphene powder mixed with PC or ABS powder and infiltrated into the polymer chain to make dense (low porosity) composite filament. In certain situations, metal nano-powders (such as copper, aluminum, silver or gold) can also be used instead of nano-diamond or nano-graphene powder.

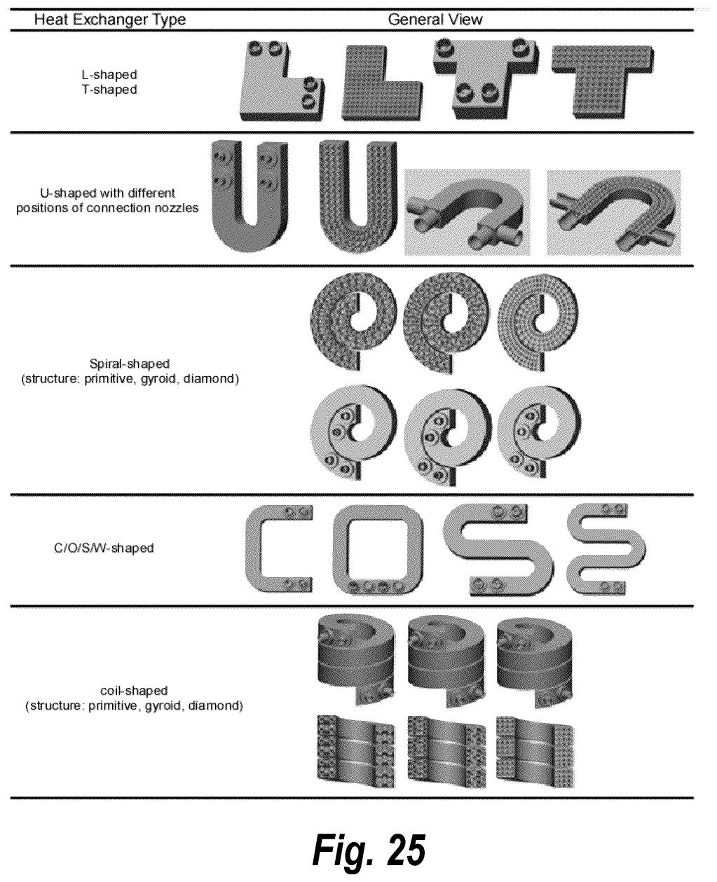

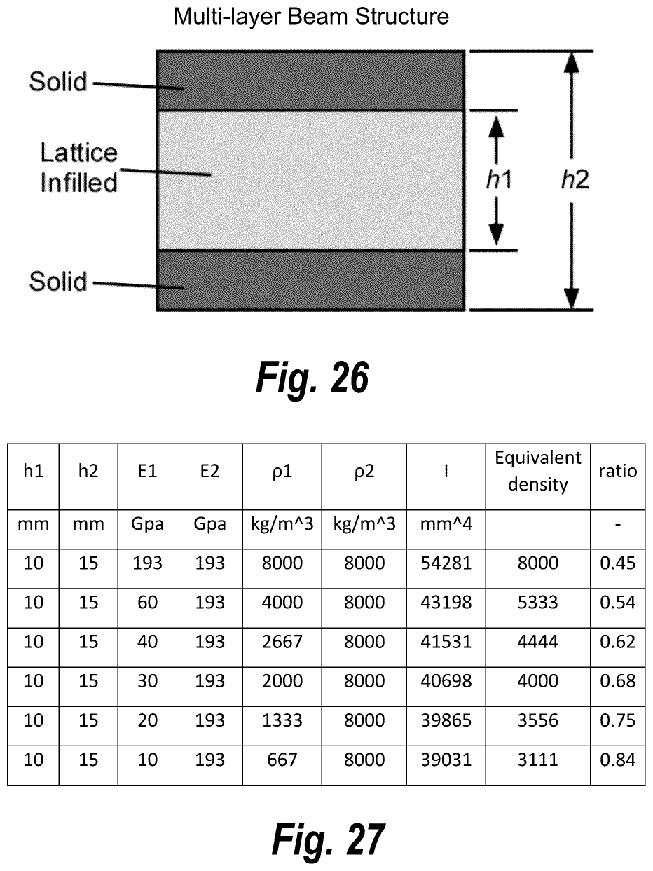

FIG. 26 is a schematic illustration of a cross section of a multi-layer beam structure, in accordance with some embodiments.

FIG. 27 is a table showing the ratio of area moment of inertia and equivalent mass of the beam with different elastic modulus, in accordance with some embodiments.

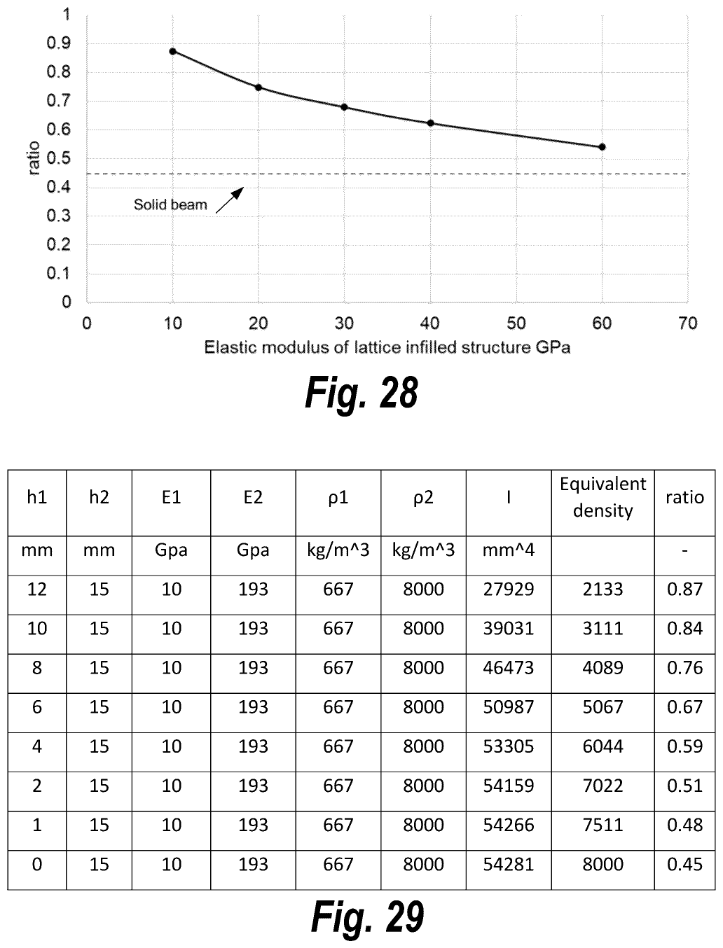

FIG. 28 is a graph showing the ratio of area moment of inertia and equivalent mass of the beam as a function of effective modulus, in accordance with some embodiments.

FIG. 29 is a table showing the modeling results of the beam with different heights.

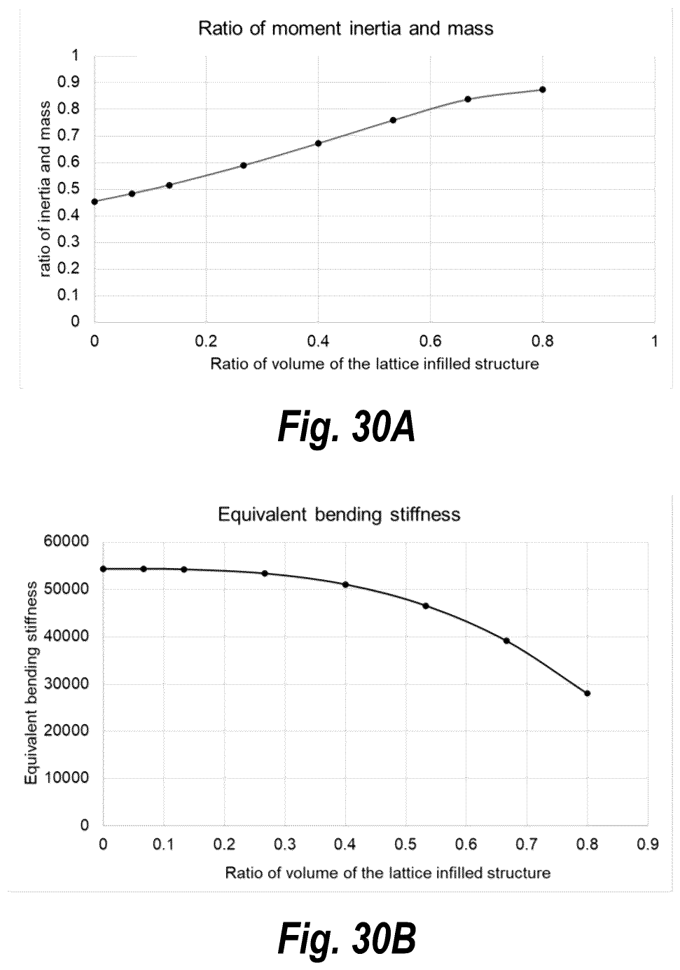

FIGS. 30A and 30B are graphs showing the simulated ratio of the beam inertia and mass versus ratio of volume of the lattice infilled structure and the equivalent bending stiffness versus ratio of volume of the lattice infilled structure, respectively, in accordance with some embodiments.

TPMS structures may also be used as mechanical structures which are capable of withstanding mechanical loads while also providing precision. The mechanical structures may comprise structures such as beams, optical breadboards, mounting plates, mounting brackets, mirror support substrates, and the like. Beam structures are the basic building blocks for optical structures. FIG. 26 shows an example of a multi-layer beam structure, for which both sides are solid material and in the middle portion, there is gyroid lattice infilled structure. The combined structure has advantages of mass reduction while maintaining strength. In this example, the ratio of area moment of inertia and equivalent mass, as defined below:

$$ratio = \frac{Equivalent beam stiffness}{Equivalent mass} = \frac{E 1 * I 1 + E 2 * I 2}{A 1 * ρ 1 + A 2 * ρ 2}$$

where E1 (the elastic modulus of the lattice infilled structure), E2 (the elastic modulus of 316L stainless steel), ρ1 (the density of the lattice infilled structure), ρ2 (the density of 316L stainless steel), and I (the area moment of inertia) are used to evaluate the performance of the beam. The goal is to increase the ratio by optimizing the design parameters. The ratio is non-dimensional and when hi is larger, the ratio will increase, too. The elastic modulus of the lattice infilled structure varied between 10˜60 Gpa. The density of the lattice infilled structure can be estimated by the elastic modulus divided by 0.01˜0.02 for different lattice as shown in the table of FIG. 27. In the calculation, 0.015 (5×5×5 mm gyroid lattice) was chosen. FIG. 28 shows that when decreasing the elastic modulus of lattice infilled structure (lower lattice density), the ratio of the beam will increase. This means the weight or mass of the beam structure is reduced. When the elastic modulus is 10 GPa (corresponding to a 15×15×15 mm lattice), the ratio is almost twice compared with the solid counterpart. Moreover, besides having a 2-3 times weight or mass reduction, this structure is stable and comparable in strength.

The table shown in FIG. 29 lists the calculated ratios of the beam for various heights. When the height of the lattice infilled structure becomes bigger, the ratio becomes bigger as well. As can be seen from the graphs of FIGS. 30A and 30B, to obtain a bigger ratio, the elastic modulus needs to be decreased and the height of the lattice infilled structure needs to be increased. This provides the foundation for a variety of optical structures such as such as mounting structures, brackets, optical benches, and metering structures.

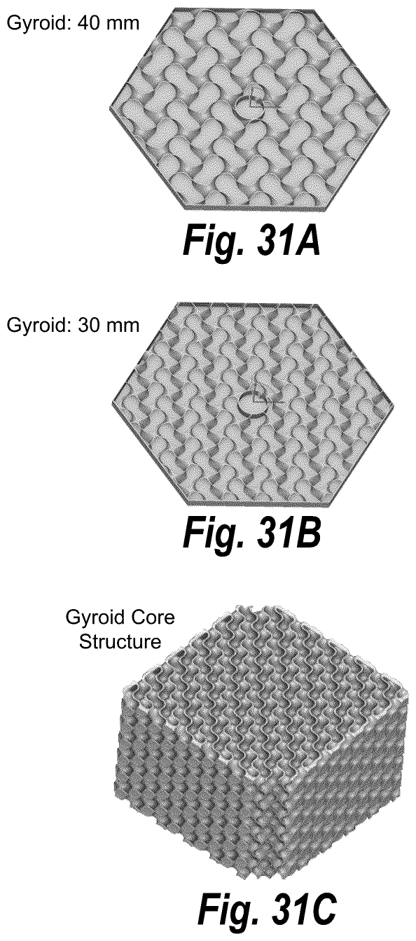

FIGS. 31A, 31B, and 31C are schematic illustrations of a gyroid mirror structure with a 40 mm lattice length, a gyroid mirror structure with a 30 mm lattice length, and a gyroid core structure, respectively, in accordance with some embodiments.

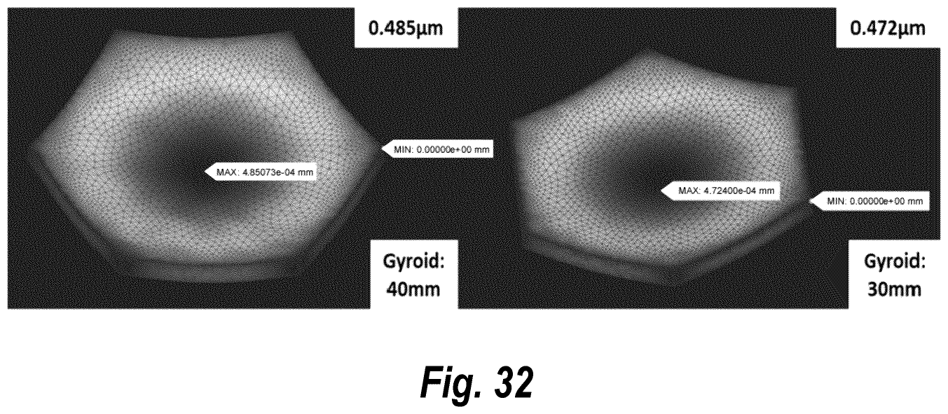

FIG. 32 shows the modeling of the gravity deformation for two Super Invar gyroid structures, one with a 40 mm lattice length and the other with a 30 mm lattice length, in accordance with some embodiments.

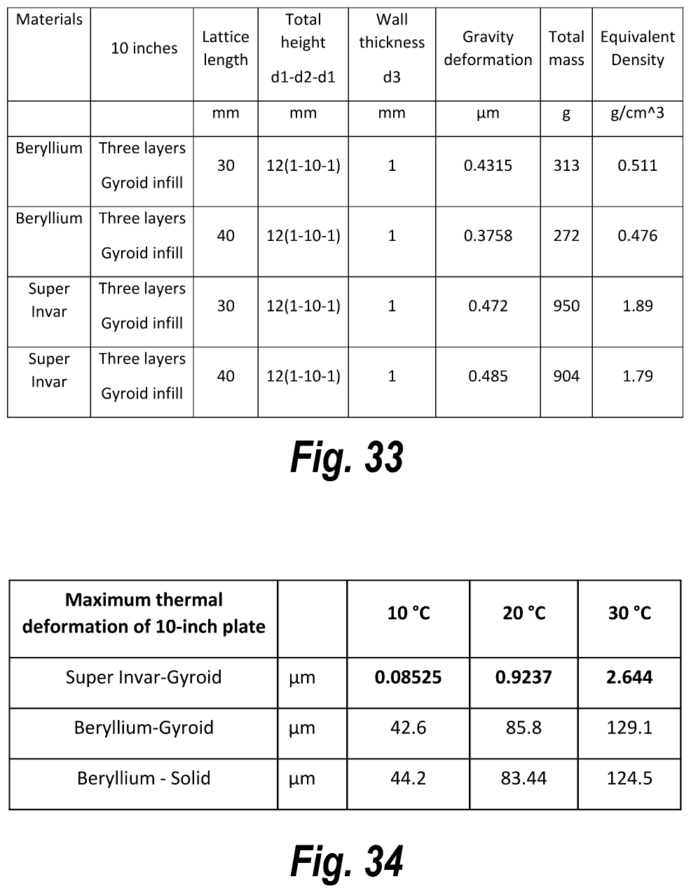

FIG. 33 is a table showing the performance comparisons between beryllium and Super Invar for a 10-inch gyroid mirror structure, in accordance with some embodiments.

FIG. 34 is a table showing the thermal deformations of 10-inch plates of gyroid Super Invar, gyroid beryllium, and solid beryllium, at various temperature differences, in accordance with some embodiments.

TPMS structures may also be used as biomimetic gyroid mirror structures. Beryllium (with a density of 1.85 g cm³, a melting point of 1287° C., a thermal conductivity of 200 Wim-K, a CTE of 11.3 ppm K, and an ultimate tensile strength of 345 MPa) has been used for extreme weigh reduction of glass mirrors. Super Invar (32% Ni, 5% Co, Fe balanced, with a density of 8.15 g cm³ and a melting point of 1687° C.) is an excellent candidate with near zero CTE (<0.5 ppm over −55° C.-95° C.) and high mechanical strength (>450 MPa). By optimizing the gyroid core structure using the topology optimization method of FIG. 3, light weight, with at least a 5× improvement compared with the solid version, mirror structures have been achieved along with the highest strength-to-weight ratio and near zero CTE.

FIGS. 31A, 31B, and 31C show schematic illustrations of a gyroid mirror structure with a 40 mm lattice length, a gyroid mirror structure with a 30 mm lattice length, and a gyroid core structure, respectively, for a schematic design of a 10-inch three-layer sandwiched gyroid mirror structure using nTopology® software. This type of structure includes a 10 mm gyroid core structure layer sandwiched between two 1 mm thick solid layers. The thicknesses of these three layers must be optimized to meet the specifications of size, temperature, and stiffness of the mirror structure. FIG. 32 shows a modeling example in comparison of the gravity deformations between two gyroid structures using Super Invar. FIG. 33 gives a performance comparison for two materials: beryllium and Super Invar. It shows that the equivalent density is reduced by 5 times compared with the solid version while keeping a comparable deformation. Further optimization on gyroid structure may lead to over a 10 times weight reduction. FIG. 34 shows thermal induced deformation modeling results for 10-inch gyroid mirror structures using beryllium and Super Invar. It does show that Super Invar has obvious advantages (two orders of magnitudes lower deformation) in thermal performance. By integrating the thermal management and mechanical stability over a wide range of temperature, Super Invar TPMS structure plays critical role for precision optics.

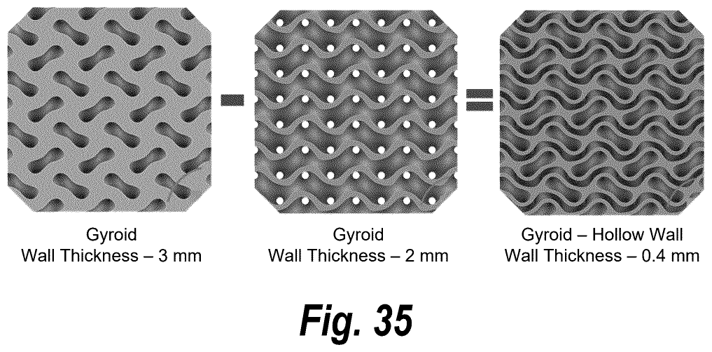

FIG. 35 is a schematic illustration of the generation of a hollow walled gyroid structure, in accordance with some embodiments.

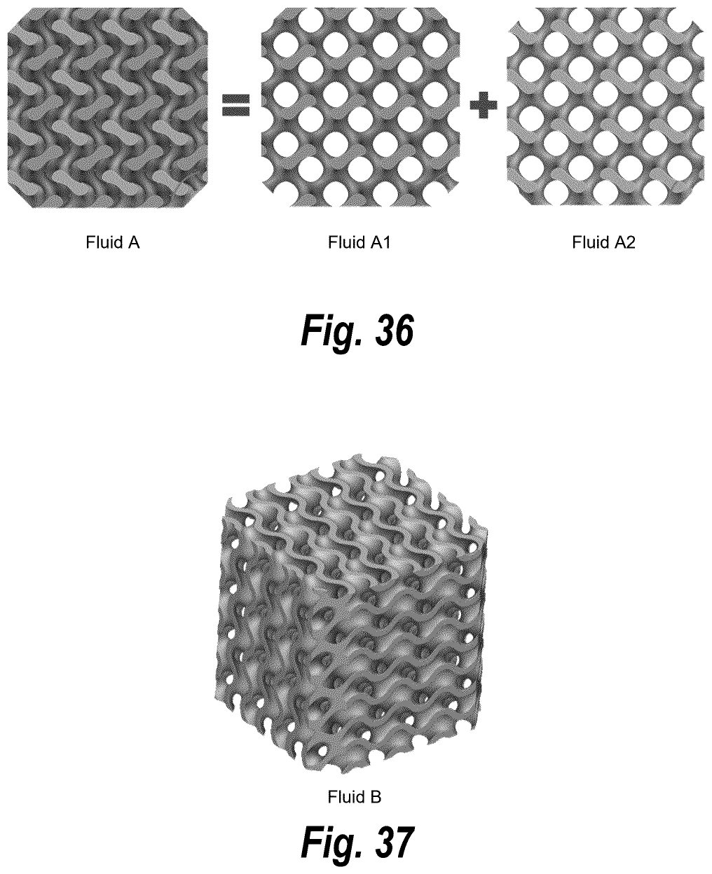

FIG. 36 is a schematic illustration of the composition of Fluid A, in accordance with some embodiments.

FIG. 37 is a schematic illustration of the thin walled gyroid structure of Fluid B, in accordance with some embodiments.

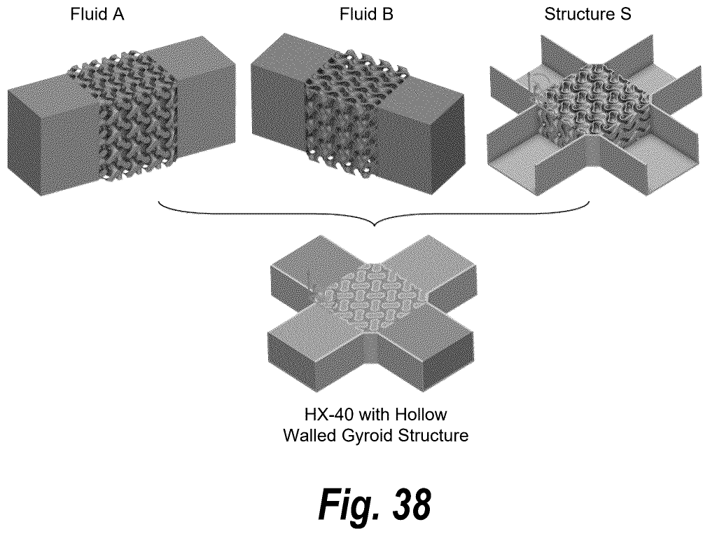

FIG. 38 is a schematic illustration of the components of an HX-40 hollow walled gyroid structure as well as a complete HX-40 hollow walled gyroid structure, in accordance with some embodiments.

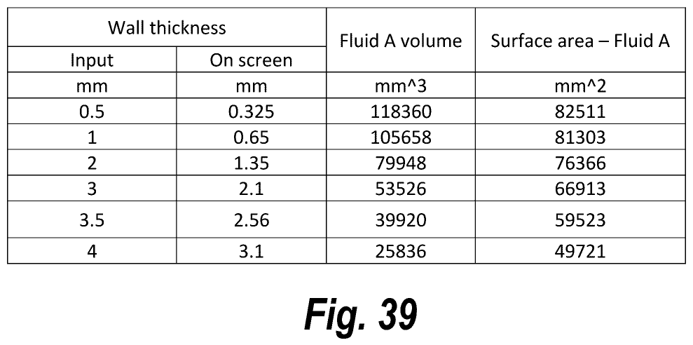

FIG. 39 is a table showing the parameters of a gyroid structure (based on the HX-40 core) with different wall thickness, in accordance with some embodiments.

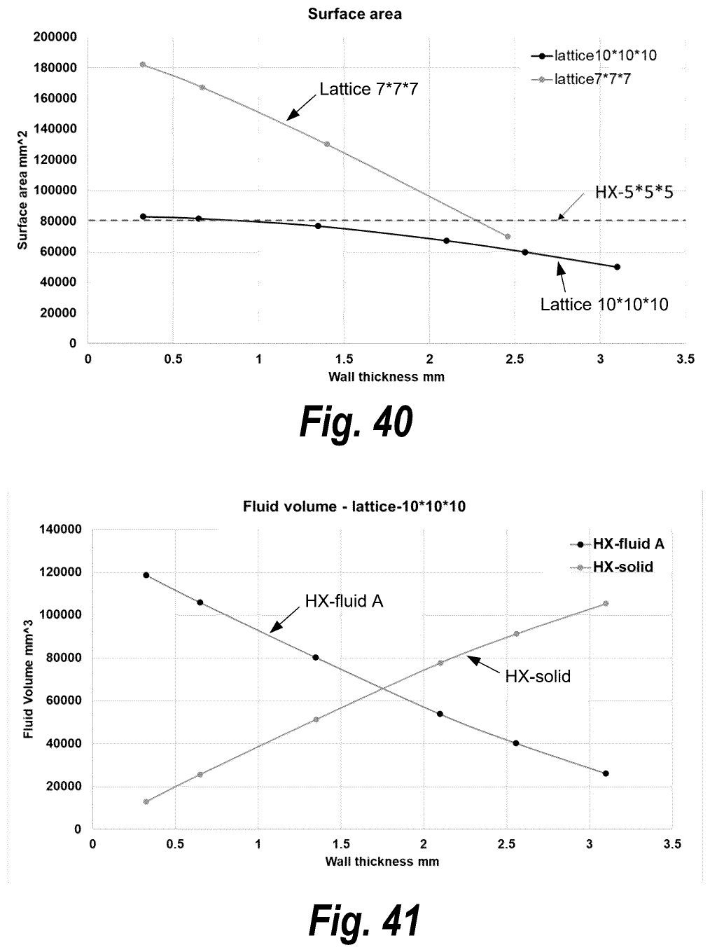

FIG. 40 is a graph of the surface area (with lattice unit lengths of 10 mm*10 mm*10 mm and 7 mm*7 mm*7 mm) as a function of input wall thickness, in accordance with some embodiments.

FIG. 41 is a graph of the Fluid A volume (with a lattice unit length of 10 mm*10 mm*10 mm) and the solid volume as a function of input wall thickness, in accordance with some embodiments.

In some embodiments, the Thermal Management Systems comprises a hollow wall triply periodic minimal surface design. As is shown in FIG. 35, the gyroid structure with hollow wall and a lattice unit length of 10 mm*10 mm*10 mm was generated by subtracting the thin walled (2 mm) gyroid structure from the thick walled (3 mm) gyroid structure. In a hollow wall TPMS, the structure for Fluid A is generated by subtracting the thick walled gyroid from the whole HX-40 core as is shown in FIG. 36 for the composition of Fluid A and the Fluid B structure is the thin walled gyroid structure as illustrated in FIG. 37. The walled channels (or hollow walled structures) for separating Fluid A and Fluid B can be designed to be the same or different to accommodate various applications. FIG. 38 is a schematic illustration of the components of an HX-40 hollow walled gyroid structure as well as a complete HX-40 hollow walled gyroid structure. The table of FIG. 39 shows the parameters of a gyroid structure (based on the HX-40 core) with different wall thickness. The parameters of FIG. 39 can be used as a guideline for the design of hollow wall gyroid structure heat exchangers. A graph of the surface area (with lattice unit lengths of 10 mm*10 mm*10 mm and 7 mm*7 mm*7 mm) as a function of input wall thickness is shown in FIG. 40. A graph of the Fluid A volume (with a lattice unit length of 10 mm*10 mm*10 mm) and the solid volume as a function of input wall thickness is shown in FIG. 41.

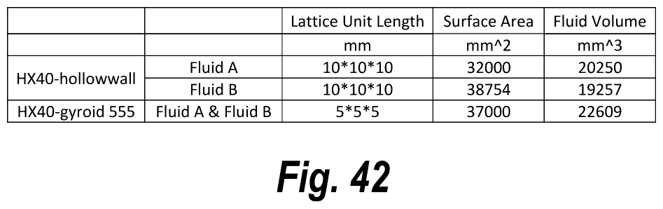

FIG. 42 is a table showing the surface areas for heat transfer and fluid volumes for an HX-40 with hollow gyroid structure and an HX-40 with gyroid lattice of 5 mm*5 mm*5 mm, in accordance with some embodiments.

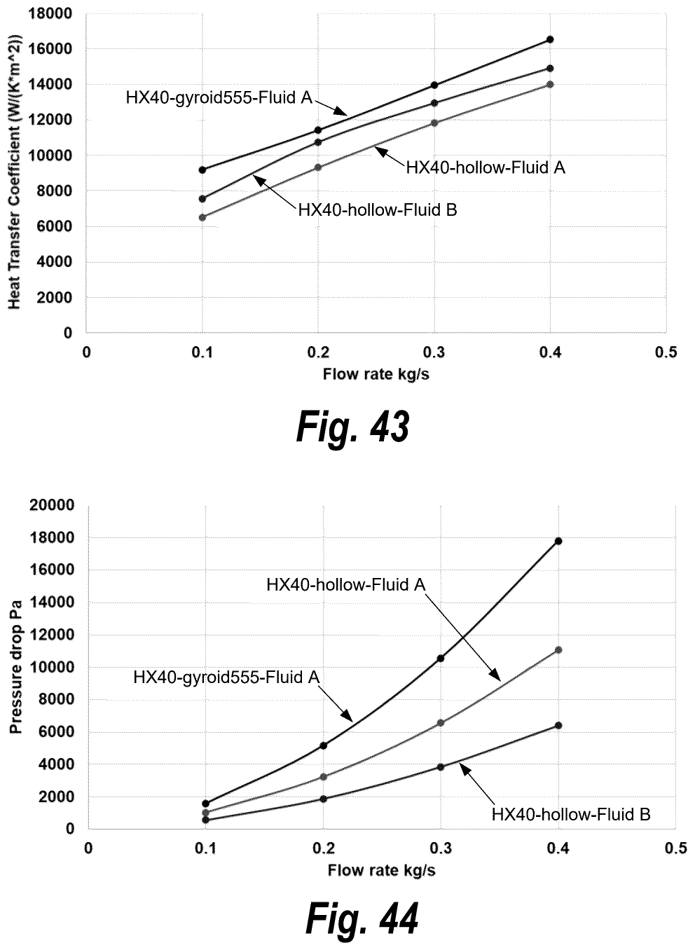

FIG. 43 is a graph of the heat transfer coefficient versus flow rate for an HX-40 with hollow gyroid structure and an HX-40 with gyroid lattice of 5 mm*5 mm*5 mm, in accordance with some embodiments.

FIG. 44 is a graph of the pressure drop versus flow rate for an HX-40 with hollow gyroid structure and an HX-40 with gyroid lattice of 5 mm*5 mm*5 mm, in accordance with some embodiments.

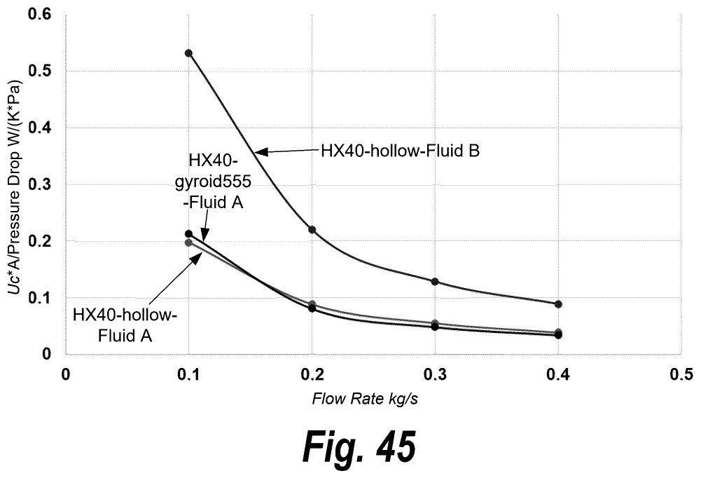

FIG. 45 is a graph of the ratio of the heat transfer coefficient times the area to pressure drop versus flow rate, in accordance with some embodiments.

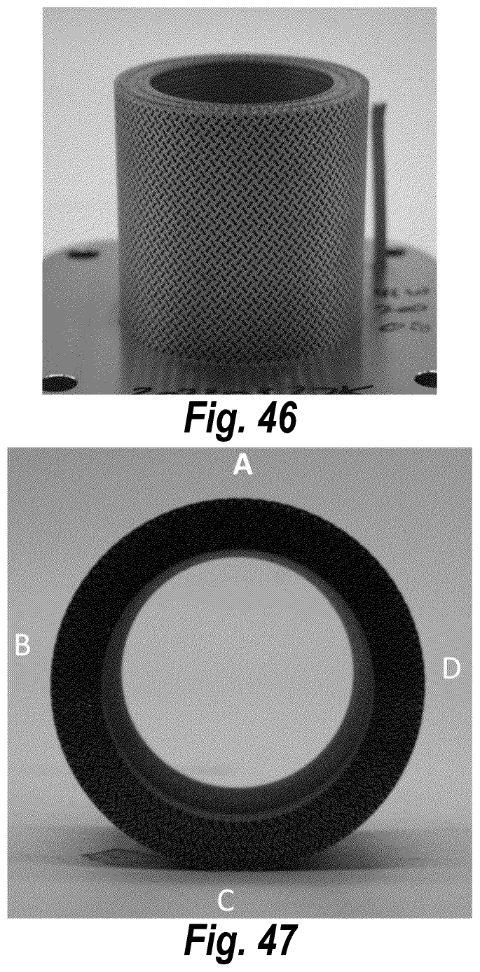

FIG. 46 is a photograph of a gyroid regenerator heat exchanger with 2 mm×4 mm×80 cells per circle layer, in accordance with some embodiments.

FIG. 47 is a photograph of the cross section of the post polished gyroid regenerator of FIG. 46, in accordance with some embodiments.

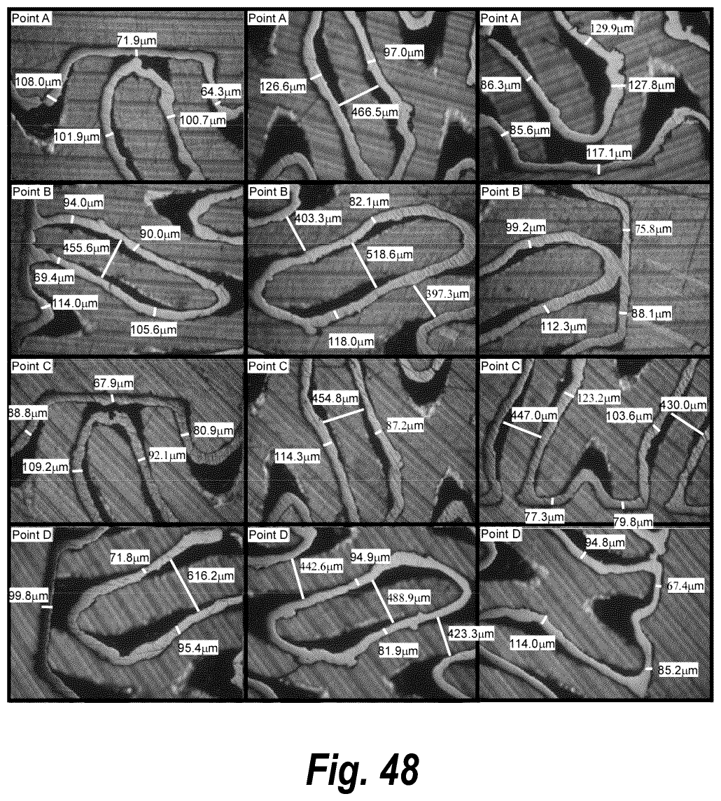

FIG. 48 are 5× microscope photographs of the post polished gyroid regenerator of FIG. 46 at points A, B, C, and D as indicated in FIG. 47, in accordance with some embodiments.

For a simulation model of the HX-40 with hollow gyroid structure, the wall thickness for the hollow wall gyroid and the solid wall gyroid are set to be the same. The wall thickness of the printed HX is about 0.7 mm. For the hollow wall gyroid structure, the input value of the thick wall is 3.4 mm and the thin wall is 1.6 mm. Based on the same wall thickness, the performance of the two structures can be compared. The table in FIG. 42 shows that the surface area of the HX-40 with hollow gyroid structure is similar to the surface area of the HX-40 with gyroid lattice of 5 mm*5 mm*5 mm. FIG. 43 shows that the HTC of the HX40-hollowwall is a little lower than that of the HX40-gyroid-555. FIG. 44 shows that the HX40-gyroid-555-Fluid A has the highest pressure drop and thus the gyroid volume will need more pressure for the same flow rate. The ratio of the heat transfer coefficient (Uc) times the area (A) to pressure drop versus flow rate can be used to rate the structure for heat exchange. FIG. 45 shows that the HX-40-hollow-Fluid B has the highest Uc*A to pressure drop versus flow rate value and thus would be a more efficient heat exchanger than the gyroid volume. The HX with hollow walled gyroid structure has several advantages, a first being that one of the fluid volumes (Fluid B) has very low pressure drop and almost the same surface area to volume ratio compared with the gyroid lattice with half the unit length. Secondly, the pressure of the two fluid volumes can be balanced by changing the dimensions. And lastly, structures with larger unit lengths are easier to print due to the curvatures of the surfaces being much bigger. Therefore, the wall thickness can be reduced further, leading to the efficiency and the pressure drop being improved. Reducing the lattice unit length of the hollow structure from 10 mm to 7 mm will increase the surface area. A disadvantage of the HX with hollow walled gyroid structure is that one of the volumes (Fluid A) has a smaller surface area and lower heat transfer coefficient. However, the ratio of Uc*A to pressure drop is almost equal to the HX gyroid structure with a lattice unit length of 5 mm. The performance of the Fluid A can be balanced by changing the dimensions. Thus it may be worth designing heat exchangers with hollow gyroid structures. FIG. 46 shows a photograph of a gyroid regenerator heat exchanger with 2 mm×4 mm×80 cells per circle layer of the regenerator. An abrasive saw was used to gently cut and polish the gyroid regenerator for inspection. FIG. 47 shows the cross section of the post polished gyroid regenerator along with the labeling of four points, A, B, C, and D, where 5× microscope inspection photographs were taken. The photographs of FIG. 48 show that the thin walls have a thickness about 70 μm to 100 μm.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

1. A method for utilizing triply periodic minimal surface structures for additive manufacturing of a thermal management system, the method comprising:
(a) determining a required heat transfer power; a required pressure drop, a required dimension restriction, a required material, and a required connector type for the thermal management system;
(b) modeling an initial volume, an initial dimension, a layout of inlet and outlet channels and connectors, a type of lattice, a unit length of the type of lattice, and a wall thickness of the type of lattice for the thermal management system;
(c) generating mesh files from the modeling of the thermal management system;
(d)using fluid simulation software to calculate the mesh and boundary conditions and to generate a simulated heat transfer power, a simulated pressure drop, and a simulated flow rate;
(e) determining if the simulated heat transfer power meets the required heat transfer power;
(f) if the determination made in step (e), above, is that the simulated heat transfer power does not meet the required heat transfer power then:
increase the initial volume,
reduce the unit length of the type of lattice, and
repeat steps (b) through (e) using the increased initial volume and reduced unit length of the type of lattice;
(g) if the determination made in step (e), above, is that the simulated heat transfer power does meet the required heat transfer power then determining if the simulated pressure drop meets the required pressure drop;
(h) if the determination made in step (g), above, is that the simulated pressure drop does not meet the required pressure drop then:
optimize the layout of inlet and outlet channels,
change the unit length of the type of lattice,
change the initial dimension for the thermal management system, and
repeat steps (b) through (g) using the optimized layout of inlet and outlet channels, the changed unit length of the type of lattice, and the changed initial dimension for the thermal management system; and
(i) if the determination made in step (g), above, is that the simulated pressure drop does meet the required pressure drop then exporting an additive manufacturing file format file for additive manufacturing of the thermal management system.

2. The method of claim 1, wherein optimizing the layout of inlet and outlet channels comprises adjusting an orientation between the triply periodic minimal surface structures and the layout of inlet and outlet channels and connectors in order reduce the simulated pressure drop.

2. The method of claim 1, wherein the thermal management system comprises a regenerator, a recuperator, a heat exchanger, or a radiator.

3. The method of claim 1, wherein the triply periodic minimal surface structures comprise a gyroid, a diamond, a Schwarz, a SplitP, an IWP, a Primitive, and/or a Fischer-Koch-S.

4. The method of claim 1, wherein the triply periodic minimal surface structures comprise hollow walls.

5. The method of claim 1, wherein the thermal management system comprises a mechanical structure.

6. The method of claim 1, wherein the mechanical structure comprises a beam, an optical breadboards, a mounting plate, a mounting brackets, a mirror support substrate, or a combination thereof.

7. The method of claim 1, wherein the thermal management system comprises a shape wherein the shape comprises an L-shape, a T-shape, a U-shape, a C-shape, an 0-shape, an S-shape, a W-shape, a spiral shape, a coil shape, or a combination thereof.

8. The method of claim 1, wherein the required material comprises aluminum alloys, steel alloys, copper alloys, Inconel alloys, Super Invar, polymers, polymer composites, polycarbonate, acrylonitrile butadiene styrene, or a combination thereof.

9. The method of claim 8, wherein the polymer composites comprise polymer/diamond composite, polymer/graphene composite, or polymer/carbon composite.

10. A thermal management system comprising:
a solid structure;
a triply periodic minimal surface structure within the solid structure, wherein the triply periodic minimal surface structure comprises a first fluid channel and a second fluid channel;
a first inlet coupled to the solid structure and configured to pass a first fluid into the first fluid channel;
a second inlet coupled to the solid structure and configured to pass a second fluid into the second fluid channel;
a first outlet coupled to the solid structure and configured to pass the first fluid out of the first fluid channel; and
a second outlet coupled to the solid structure and configured to pass the second fluid out of the second fluid channel.

11. The thermal management system of claim 10, wherein orientations between the triply periodic minimal surface structure and the first inlet, the second inlet, the first outlet, and the second outlet are configured for reduced flow resistance between the first inlet, the first fluid channel, and the first fluid outlet and for reduced flow resistance between the second inlet, the second fluid channel, and the second fluid outlet.

12. The thermal management system of claim 10, wherein the thermal management system comprises a regenerator, a recuperator, a heat exchanger, or a radiator.

13. The thermal management system of claim 10, wherein the triply periodic minimal surface structures comprise a gyroid, a diamond, a Schwarz, a SplitP, an IWP, a Primitive, and/or a Fischer-Koch-S.

14. The thermal management system of claim 10, wherein the triply periodic minimal surface structure comprises hollow walls.

15. The thermal management system of claim 10, wherein the thermal management system comprises a mechanical structure.

16. The thermal management system of claim 15, wherein the mechanical structure comprises a beam, an optical breadboards, a mounting plate, a mounting brackets, a mirror support substrate, or a combination thereof.

17. The thermal management system of claim 10, wherein the thermal management system comprises a shape wherein the shape comprises an L-shape, a T-shape, a U-shape, a C-shape, an O-shape, an S-shape, a W-shape, a spiral shape, a coil shape, or a combination thereof.

18. The thermal management system of claim 10, wherein the triply periodic minimal surface structure comprises a material, wherein the material comprises aluminum alloys, steel alloys, copper alloys, Inconel alloys, Super Invar, polymers, polymer composites, polycarbonate, acrylonitrile butadiene styrene, or a combination thereof.

19. The thermal management system of claim 18, wherein the polymer composites comprise polymer/diamond composite, polymer/graphene composite, or polymer/carbon composite.
